(19) United States
(12) Patent Application Publication
(10) Pub. No.: US 2004/0071351 A1
(43) Pub. Date: Apr. 15, 2004

(54) Method and system for graphics compression and display

(76) Inventor: Johan Rade, Cary, NC (US)

Correspondence Address: JONES DAY, 222 EAST 41ST STREET, NEW YORK, NY, 10017, US

(21) Appl. No.: 10/680,374

(22) Filed: Oct. 7, 2003

Related U.S. Application Data
(60) Provisional application No. 60/416,487, filed on Oct. 7, 2002.

(51) Int. Cl. G06K 9/36

(52) U.S. Cl. 382/232

(57) ABSTRACT

In a preferred embodiment, the invention comprises a system for graphics compression and display. The system has a compression component and a decompression component. The compression component comprises a simplifier module and a lossless compressor module, and the decompression component comprises a decompressor module and a renderer module. The simplifier module performs lossy compression based on histogram-based quantization. The lossless compressor module performs run-length encoding of color regions and adaptive Golomb coding of color values. The decompressor module receives a compressed file and outputs a corresponding file that is in a device independent intermediate format comprising decoded global parameters; a device independent color table; and pairs of colors and run-lengths. The renderer module receives a decoded device independent color table and converts the table into one or more device dependent colors.

### CROSS-REFERENCE TO RELATED APPLICATIONS

This application claims priority to U.S. provisional patent application No. 60/416,487, filed Oct. 7, 2002. The entire contents of that provisional application are incorporated herein by reference.

### BACKGROUND

Graphic images (i.e., “graphics”) generated on computers, such as greeting cards, cartoons, icons, artwork, etc., occupy a large amount of storage space and take a long time to transmit from one computing device to another. As a result, a number of graphics compression schemes exist. The compression of a graphic is either lossless or lossy. Lossless compression means that the graphic is recovered from the compressed version without the loss of any information; in other words, the decompressed graphic is identical to the original graphic. In lossy compression, the goal is to generate a decompressed graphic that differs only slightly from the original graphic and, at the same time, produce a compressed version that is much smaller than the original. In general, lossy compression schemes produce smaller compressed files than lossless compression schemes.

Examples of lossless compression schemes are GIF, PNG, BMP, and JBIG, which is the compression standard for bi-level or binary images. An example of a lossy scheme is JPEG. TIFF has options for both methods. A brief overview of these schemes is presented in the following paragraphs; each scheme is described in much more detail in the references.

GIF (Graphics Interchange Format) is CompuServe's standard for graphics image data exchange (see http://www.prepressure.com/formats/gif/fileformat.htm). Image data in the GIF file format is compressed using a modified Lempel, Ziv, and Welch (LZW) algorithm. Terry A. Welch described LZW in the June 1984 issue of IEEE's Computer magazine (see Terry A. Welch, “A technique for high-performance data compression”, IEEE Computer, June 1984, pages 8-19). Unisys holds a patent (see High speed data compression and decompression apparatus and method, U.S. Pat. No. 4,558,302, Terry A. Welch, Sperry Corporation, 1983) on the procedure described in the article. The main disadvantage of GIF is the number of colors that can be used for representing image data. The bit depth of an image can be no more than 8 bits per pixel, which means that a maximum of 256 different colors can be found in a single GIF image. Despite this limitation, GIF still remains a popular choice for storing lower resolution image data (see http://www.faqs.org/faqs/graphics/fileformats-faq/part3/section-57.html).

PNG (pronounced “ping”) is the Portable Network Graphics format. The PNG format provides a portable, well-compressed, and well-specified standard for lossless bitmapped image files. Some of its features include: 1-, 2-, 4- and 8-bit palette support (like GIF), 1-, 2-, 4-, 8- and 16-bit grayscale support, and 8- and 16-bit-per-sample (in other words, 24- and 48-bit) true color support (see http://www.libpng.org/pub/png/ and http://www.w3.org/Graphics/PNG/). PNG has been approved as an informational Request For Comments (RFC) by the World Wide Web Consortium, but has not yet been formally issued by IETF (see http://www.w3.org/TR/REC-png).

BMP is a native bitmap format of MS Windows, and it is used to store (virtually) any type of bitmap data. Most applications running under MS Windows (MS DOS) and under other operating systems support reading from and writing to BMP files. Support for Run-Length Encoding (RLE) compression was added in Windows 3.0 and can be either RLE4 or RLE8. RLE8 is run-length encoding used for a 256 color bitmap (8 bits-per-pixel) and RLE4 is run-length encoding used for a 16 color bitmap (4 bits-per-pixel) (see http://www.fortunecity.com/skyscraper/windows/364/bmpfformt.html and http://msdn.microsoft.com/library/default.asp?url=/library/en-us/gdi/bitmaps_{—}1rw2.asp).

JPEG stands for Joint Photographic Experts Group, the original name of the committee that wrote the image compression standard. JPEG is a lossy compression method designed for compressing either full-color or gray-scale images of natural, real-world scenes. It works well on photographs, naturalistic artwork, and similar material; not so well on lettering, simple cartoons, or line drawings (see http://www.faqs.org/faqs/jpeg-faq/).

The TIFF (Tag Image File Format) specification was released in 1986 by Aldus Corporation (now Adobe System Inc.). The designers of the TIFF file format had three important goals in mind: extendibility, portability, and flexibility (see http://home.earthlink.net/˜ritter/tiff/). Some of its other features are scalable color depth from 1-bit (b/w) to 24-bit (true color) and support for numerous compression schemes: uncompressed, RLE, LZW, CCITT Group 3&4 Fax, JPEG and PackBits. If one needs to format an image in BMP, GIF, JPEG, scanned fax document, or any non-vector image, and one wants a rich description of that image with all details, then TIFF may be the right choice (see http://www.designer-info.com/master.htm?http://www.designer-info.com/Writing/bmp_tiff_jpeg_gif.htm).

JBIG is short for the “Joint Bi-level Image Experts Group,” who developed IS 11544 (ITU-T T.82) for the lossless compression of a bi-level image (see http://wwwjpeg.org/jbighomepage.html). JBIG losslessly compresses binary (one-bit/pixel) images. Basically, it models the redundancy in the image as the correlations of the pixel currently being coded with a set of nearby pixels called the template. The current pixel is then coded using the arithmetic coder and probability estimator for the contexts in IBM's (patented) Q-coder (see Arithmetic coding encoder and decoder system, U.S. Pat. No. 4,905,297, Langdon Jr. et al, International Business Machines, 1990). A description of the Q-coder as well as the ancestor of JBIG in the November 1988 issue of the IBM Journal of Research and Development (see W. B. Pennebaker, J. L. Mitchell, G. G. Langdon, R. B. Arps, “An overview of the basic principles of the Q-coder adaptive binary arithmetic coder”, IBM Journal of research and development, Vol.32, No.6, November 1988, pp. 771-726). There is no official JBIG file format. A JBIG data stream must be dumped into a disk for tape file and given an extension JBG or JBIG, then a JBIG file is created (http://www.faqs.org/faqs/compression-faq/part2/).

Thus, graphics generated on computers are stored in either vector or graphic formats that generally store the data in a compressed form. The two most common raster graphic formats are PNG and GIF. Since these compression formats are targeted for the computer user, compression is usually lossless and no special methods for displaying the files are included as part of the decompression specifications. Other compression formats exist that support lossy compression, like JPEG, TIFF, and others. These formats are generally targeted towards real-world photographs and images and provide high compression ratios, but decompressed graphics show visible artifacts.

The requirements for displaying images on a mobile device differ significantly from those for a computer. Mobile devices generally have much less processing power and memory (both run-time memory and storage memory), and low-bandwidth network connections. Furthermore, the color depth of mobile devices range from black-and-white displays to 16-bit color (and, in some cases, even 24-bit color) displays. Given this range of display devices, either multiple copies of the same graphic have to be generated to support each display type, or a generic graphic format must be developed that includes decompression and display routines for all display types from the same compressed file. While the aforementioned graphics formats may provide solutions to some of these problems, the present invention alone provides a solution to all such problems.

The present invention builds on some prior art compression techniques, including Run-Length Encoding, Golomb Coding, and Huffman Coding.

Run-length encoding (RLE) is based on a simple principle of encoding data and can be applied to any data stream that has segments consisting of the same data values (the repeating values are called a run). The principle is that a sequence of repeated data values is replaced with a count number and a single value. This intuitive principle works best on certain data types in which sequences of repeated data values can be noticed; RLE is usually applied to files that a contain large number of consecutive occurrences of the same byte pattern.

RLE may be used on any kind of data, regardless of its content. But the actual compression ratio that will be achieved by RLE is determined by the contents of the data. RLE can be used on text files that contain multiple spaces for indenting and formatting paragraphs, tables and charts. Digitized signals also consist of unchanged streams, so such signals can also be compressed by RLE. Good examples of such signals are monochrome images, but only a small amount of compression would typically be achieved if RLE were used on continuous-tone (photographic) images. Better compression ratios are usually achieved if RLE is applied to computer-generated color images.

RLE is a lossless compression technique and thus achieves smaller compression ratios compared to lossy compression methods. But RLE is a fast and compact (in the size of code) compression and decompression method (see http://www.arturocampos.com/ac_rle.html).

Golomb Coding was described in 1966 by Soloman Golomb of the University of Southern California (see S. W. Golomb, “Run-length encoding”, IEEE Trans. Inform. Theory, volume IT-12, pp.399-401, 1966). If the data to be coded follows a geometric distribution, Golomb codes form a surprisingly effective Huffman-style code, even more useful than arithmetic coding. For some parameter b, any number x>0, is coded in two parts: first, q+1 in unary, where the quotient q=└(x−1)/b┘; then the remainder r=x−qb−1 coded in binary, requiring either └logb┘ or ┌log┐ bits. Golomb coding gives results within a few percent of the compression obtained by a Bernoulli model with arithmetic coding for inverted file compression (see Ian H. Witten, Alistair Moffat, Timorty C. Bell, “Inverted file compression”, Managing Gigabytes: compressing and indexing documents and images, Section 3.3, pages 119-121).

Huffman coding is a standard entropy-based coding scheme that gives a reduction in the average code length used to represent the symbols of an alphabet (see http://www.faqs.org/faqs/compression-faq/part2/) and is described in detail in a number of data compression books including Mark Nelson and Jeanloup Gailly, “The Data Compression Book,” 2nd Edition, M&T Books; New York, N.Y.; 1995.

### SUMMARY

The present invention comprises a method and system for the compression/decompression and display of graphics. A preferred embodiment of the system of the invention is referred to herein as the BlueFuel™ Raster Graphics (BFRG) system and comprises a preferred BFRG Compression sub-system 110 and a preferred BFRG Decompression sub-system 120. See FIG. 1. In order to accomplish both lossless and lossy modes of compression of graphics, the preferred BFRG Compression sub-system 110 includes a preferred Simplifier 210 and a preferred Lossless Compressor 220. See FIG. 2. A compressed file generated by the preferred BFRG Compression sub-system 110 is stored in a flexible, compact, and extensible file format—the BlueFuel Raster (BFR) file format. A BFR file includes a device independent color table and compressed data for a graphic. The preferred BFRG Decompression sub-system 120 includes two modules. See FIG. 3. The first module, the preferred Decompressor 310 module, decodes a BFR file and generates a compact and device independent intermediate format file. The second module, the preferred Renderer module 320, takes as input the intermediate format file and the device independent color information and generates device dependent colors. Then, using the device dependent colors and, optionally, standard image processing techniques, module 320 creates different views of the graphic.

Aspects of the present invention comprise a flexible, compact, portable and extensible file format, a system and method to generate a lossless version of the file format, a system and method to generate a lossy version of the file format, and a system and method for decompressing and displaying from the file format. A flexible, compact, portable and extensible preferred file format is provided that supports both the lossless and lossy compression of raster images on a wide range of devices, ranging from simple cell phones to the most advanced computers. A system and method to generate a lossless version of the file format is based on a device-independent color table, an estimator of encoding parameters, a predictor of color and run-lengths in the raster image from data previously encoded, and an entropy encoder of data resulting from the prediction process. A system and method to generate the lossy version of the file format is based on simplification of the raster image. A system and method for decompressing and displaying from the file format is based on a decompression component that generates a device-independent and compact intermediate format, followed by a display component that renders a device-dependent view of the raster image.

### BRIEF DESCRIPTION OF THE DRAWINGS

FIG. 1 depicts preferred components of a preferred embodiment of the present invention.

FIG. 2 depicts overall structure of a preferred BFRG Compression sub-system 110.

FIG. 3 depicts overall structure of a preferred BFRG Decompression sub-system 120.

FIGS. 4-9 illustrate a number of examples that demonstrate the behavior of the preferred color and run-length predictor used by Lossless Compressor 220.

### DETAILED DESCRIPTION OF PREFERRED EMBODIMENTS

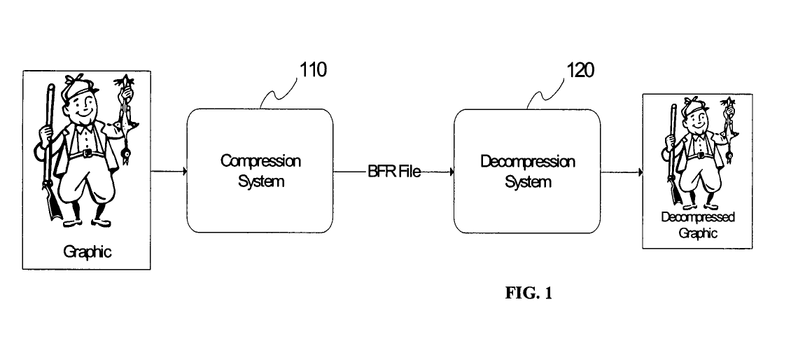

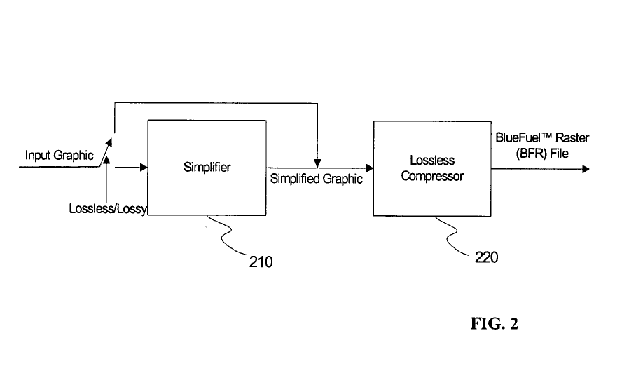

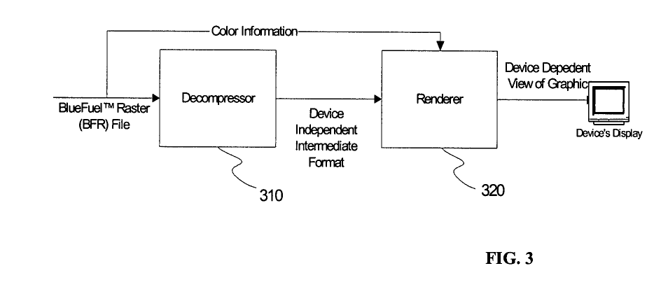

In the following, we describe preferred embodiments of the systems and methods of the present invention. A preferred embodiment of the BFRG system comprises components to encode, decode, and display graphics on a wide range of devices. The BFRG system is designed to support both lossless and lossy compression of graphics and consists of a preferred BFRG Compression sub-system 110 and a preferred BFRG Decompression sub-system 120. See FIG. 1. A preferred BFRG Compression sub-system 110 encompasses two parts related to encoding graphics: (a) a lossy graphics simplification method and (b) a lossless compression scheme. See FIG. 2. The compressed files generated by the preferred BFRG Compression sub-system are in the BlueFuel™ Raster (BFR) file format. The decompression sub-system 120 methods are related to both the decoding of a compressed BFR file to an intermediate format and the display of the decoded graphic on a wide range of devices. See FIG. 3.

Preferred BFRG Compression Sub-System

FIG. 2 shows a system diagram of the preferred BFRG Compression sub-system 110. This sub-system comprises two modules: a preferred Simplifier 210 and the preferred Lossless Compressor 220. The goal of the preferred Simplifier 210 is to reduce the number of colors in the image and to make the color regions as large and as simple as possible while maintaining acceptable visual quality. The resulting simplified graphic usually differs from the original graphic. This kind of compression is called lossy compression. The preferred Simplifier step provides lossy compression in the BFRG system. This step is optional, but is considered very useful, especially if the images are intended for devices that support only a few colors. The Lossless Compressor 220 compresses the information contained in the graphic in an efficient format for transmission.

In one embodiment of the BFRG system, the input graphic is in BMP format with 1-, 4-, 8-, or 24-bit color depth, and the simplified graphic is also stored in BMP format with 1-, 4-, 8-, or 24-bit color depth. The compressed graphic is stored in the BFR format. However, the same methods described herein and used in the BFRG system could also be applied to graphics in other formats and with other color depths.

Preferred Simplifier

The goal of the Simplifier 210 is to reduce the number of colors in the graphic and to make the color regions as large as possible (with the goal of creating color run-lengths as long as possible) while maintaining acceptable visual quality. Lossy compression in the BFRG Compressor sub-system 110 takes place primarily in the Simplifier 210.

A known method of reducing the color set in a graphic is to quantize the color values by rounding. For instance, quantizing a graphic in 24-bit color format to 8-bit color format reduces the number of colors from a maximum of 2²⁴≈16.8 million colors to a maximum of 2⁸=256 colors. Generally, due to the limitation on the color set (only 256 colors), a palette-based representation of the color set is used. This palette-based representation results in an encoding of the raster graphics data that produces a better quality raster graphic than the rounding quantization approach.

The straight rounding quantization approach also has a major drawback—it tends to create noisy quantized images, especially in regions of the image where the pixel values fluctuate across quantization boundaries. Many graphics contain anti-aliasing pixels that serve to visually sharpen the edges of objects in the image. These anti-aliasing pixels may be close in value to the perceived color of a region, but may differ from the region color enough so that they are quantized to a different shade. These anti-aliasing pixels, which were not perceptible in the full color-depth graphic, are now visible as isolated off-shade pixels. In addition to the distracting visual effect, these isolated pixels also make further compression less efficient because they increase the number of colors in the graphic and reduce the size of uniform color regions.

The Simplifier 210 provides a better solution, reducing the occurrence of isolated off-shade pixels while still maintaining the compression benefits of color quantization. In the standard rounding quantization described above, the maximum allowed error between an input pixel and its quantized value is q/2, where q is the quantization step. In the BFRG system, larger error values are allowed. The effect of this larger allowed error is that each input pixel value corresponds to a set of a few allowed quantized values. The correct quantized value for a particular pixel is determined based on histograms of the color content in the graphic. The preferred histogram process is as follows:

1. A straight rounding quantization is computed over the entire raster graphic.

2. Standard histogram-based color reduction techniques (for instance, a global histogram) are computed across the entire raster graphic. For instance, based on the global histogram data, isolated regions of similar input color are set to the same quantized color.

3. Local histograms are computed for each pixel position in the raster graphic. Only colors within a pre-defined tolerance level from the color of the current pixel are included in the histogram. If the color of the current pixel does not match the most common color in the local histogram and the frequency of the most common color exceeds the frequency of the color of the current pixel by a pre-defined threshold, then the current pixel is changed to match the most common color in the local histogram. The system preferably iteratively uses diamond-shaped windows of sizes 7×7, and 5×5, but the same approach may be used with other window shapes and sizes. For instance, another approach is to use a square-shaped 9×9 or 11×11 local histogram window centered on the current pixel.

This histogram-based approach results in larger regions and fewer colors, compared to the straight quantization.

Preferred Lossless Compressor

The lossless compression scheme used in the Lossless Compressor 220 comprises the following: (a) creation of device independent color table; (b) estimation of encoding parameters; (c) prediction of colors and run-lengths in the graphic; and (d) entropy encoding of the code words and other data generated by the prediction. Overall, the compression algorithm is based on the run-length coding of color regions. In standard run-length encoding of images, color regions are expressed in terms of (c, r) pairs, where c is a color value and r is the length of a run of that color across a row of pixels. To the creation of a device independent color table the BFRG system adds estimation of encoding parameters, prediction based on information from the previous row and previous pixels of the current row, and entropy coding to efficiently represent the prediction, color, and run-length data.

Creation of Device Independent Color Table

The color table information is extracted from the input graphic and converted into a compact binary form for storage as part of a compressed BFR file. Each color preferably is stored in either 16-bit color or 24-bit color precision.

Estimation of Encoding Parameters

In order to maximize entropy encoding efficiency, the prediction and entropy encoding process, described in detail in the following paragraphs, is simulated. The frequency of each color that is coded is calculated and the Golomb parameter used in the Golomb encoding of data related to the colors is determined.

Color and Run-Length Prediction

The predictor allows the BFRG system to predict the upcoming color and run-length based on the previous row of pixels and the previous pixels on the current row. There are three modes of predictor behavior, each indicated by a predictor code word. For each code word, a suffix further defines the behavior of the predictor. Table 1 below shows the meaning and usage of the predictor code words.

TABLE 1
Predictor Code Words

| C | Meaning | | Usage |
|---|---|---|---|
| C₁ | Use prediction | None | Use the predicted color and |
| | exactly | | run-length values. |
| C₂ | Adjust prediction | Adjustment Value | Use the predicted color but |
| | | | change the run-length by |
| | | | the Adjustment Value. |
| C₃ | Do not use | (Color, Run-length) | Do not use the prediction; |
| | prediction | pair | instead, use the transmitted |
| | | | color and run-length pair. |

Suppose the BFRG Compressor sub-system 110 calls the predictor at the pixel location given by the co-ordinates (i, j) in the graphic. Furthermore, let color “lc” be the color of the last encoded run. Now, the next color and run-length are predicted based on the previous row of pixels and the previous pixels on the current row. Beginning at the position immediately above the pixel to be predicted, at position (i−1, j), the predictor searches across the row to the right until a color different from the previously drawn color “lc” is found. This new color becomes the predicted color “pc”. The predicted run-length value is then chosen so that the predicted run ends at the same horizontal position as the corresponding run on the previous row, the corresponding run on the previous row being the run associated with color “pc”.

Note that the run-lengths are not required to end at the last column of a row and can wrap around to include pixels on the next row. In particular, in the extreme case, the run corresponding to the previously drawn color “lc” may end only at the pixel left of the current pixel, at position (i j−1), so no run-length for the predicated color “pc” can be predicted. Also, no prediction is done for the pixels on the first row of the graphic. So, while this prediction model does not necessarily produce good results in all cases, the predictor codeword C₃ will eliminate the cases where the prediction error is either too large or it is impossible to calculate a prediction.

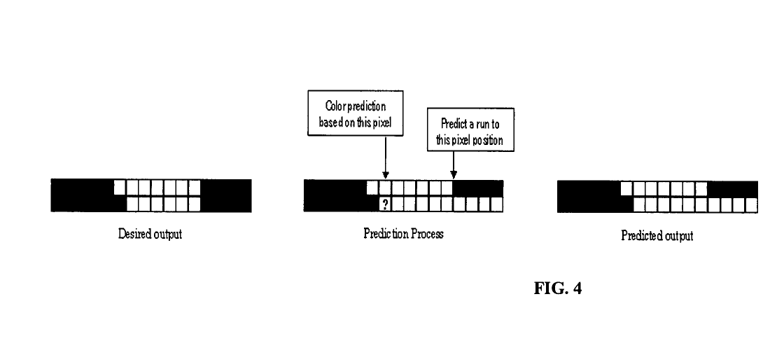

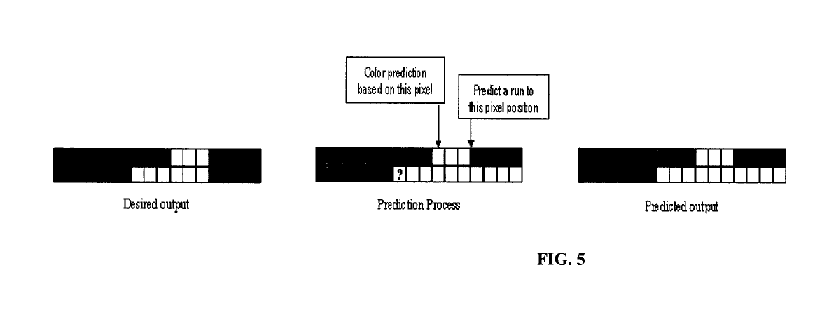

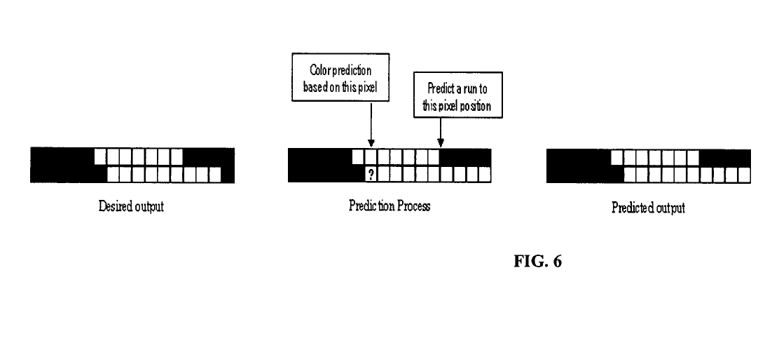

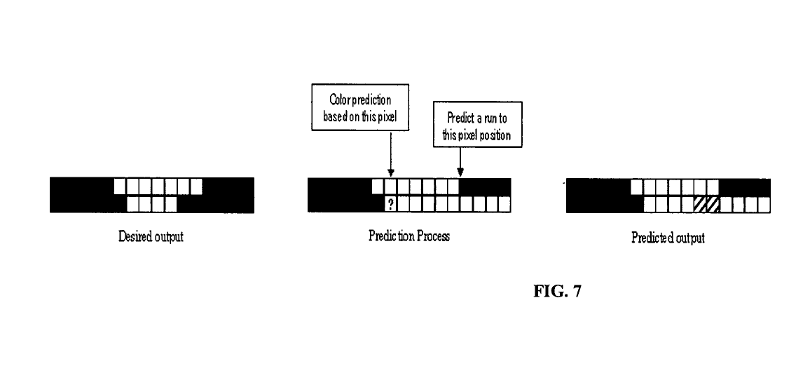

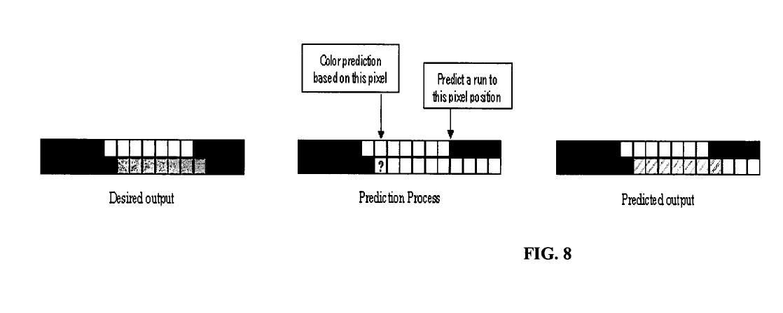

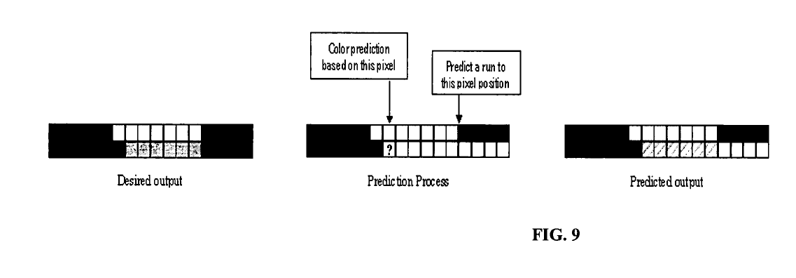

FIGS. 4-9 depict a number of examples that illustrate the behavior of the predictor. In each case, the desired output and the predicted output are shown along with a diagram that shows how the color and run-length predictions are determined. Errors in the predicted output are indicated with diagonal shading.

Multi-State Huffman Coding of Prediction Code Words

The bit symbols for the three prediction code words are based on a multi-state Huffman coding scheme. The encoder has two possible states, shown in Table 2 below.

When a C₁ case is encountered, the encoder automatically sets its state to “A” for the next symbol. When a C₃ case is encountered, the encoder automatically sets its state to “B” for the next symbol. Case C₂ is significantly less frequent than either C₁ or C₃, so a two-bit symbol is always used for C₂ and the occurrence of a C₂ case never causes the state of the encoder to change. The system is initially set to state “B”.

TABLE 2
Huffman symbols for prediction code words.

| Prediction Codeword | State “A” Codes | State “B' Codes |
|---|---|---|
| C₁ | 0 | 11 |
| C₂ | 10 | 10 |
| C₃ | 11 | 0 |

Adaptive Golomb Coding of Color Values

The color values preferably are encoded using a semi-adaptive Golomb coding scheme. Golomb codes are well suited to data with an exponential probability distribution; when the color values are sorted in order of the number of occurrences in the compressed graphics file, the exponential probability distribution fits well for typical graphics data.

Table 3 below shows the Golomb symbols that are used in the preferred BFRG implementation of the Golomb coding scheme. The Golomb parameter k defines the number of bits, excluding the prefix bits, that are used to represent code words and can be any non-negative number. The prefix bits follow a fixed sequence: 1, 01, 001, 0001, and so on. Hence, for k equal to 1, only 1 bit is used to represent values after the prefix. In other words, there are only two code words per prefix. The color values are sorted in order of occurrence so that the most commonly occurring color in the graphics data file is given the value 0; the next most common is given the value 1, etc. For more information on the Golomb coding scheme and Golomb codes, see S. W. Golomb, “Run-length encoding”, IEEE Trans. Inform. Theory, volume IT-12, pp.339-401, 1966.

TABLE 3
Golomb Codes for K = 0, 1 or 2.

| Color | | | |
|---|---|---|---|
| Value | k = 0 | k = 1 | k = 2 |
| 0 | 1 | 10 | 100 |
| 1 | 01 | 11 | 101 |
| 2 | 001 | 010 | 110 |
| 3 | 0001 | 011 | 111 |
| 4 | 00001 | 0010 | 0100 |
| 5 | . | 0011 | 0101 |
| 6 | . | . | 0110 |
| 7 | . | . | 0111 |
| 8 | | . | 00100 |
| 9 | | | 00101 |
| 10 | | | . |
| 11 | | | . |
| . . . | | | . |

Fixed Table Prefix Coding of Run-Length Values

The run-length values preferably are encoded using a binary-prefix and binary-expansion coding scheme. The symbols consist of a run of k−1 zeros followed by k bits that give the binary expansion of the run-length value. Table 4 illustrates the coding pattern. Run-length values are coded if the prediction code word is C₃. If the prediction code word is C₂, a run-length adjustment is encoded. This run-length adjustment is encoded as a sign bit followed by the size of the run, and the sign bit is 0 if the adjustment is non-negative and 1 otherwise. The size of the run is encoded using the same binary-prefix and binary-expansion method described above.

TABLE 4
Binary-Prefix and Binary-Expansion codes for run-length values.

| Run-length Value | Prefix Code |
|---|---|
| 1 | 1 |
| 2 | 010 |
| 3 | 011 |
| 4 | 00100 |
| 5 | 00101 |
| 6 | 00110 |
| 7 | 00111 |
| 8 | 0001000 |
| . . . | . . . |

Preferred BFRG Decompression Sub-System

The BFRG Decompression sub-system 120 comprises two components. The first component decompresses a BFR file to a compact and device independent intermediate format. The second component takes as input the intermediate format file and renders different views of the decompressed graphic fine-tuned to the device's display unit.

Preferred Decompressor

The Decompressor 310 takes as input a BFR file. This file may be downloaded via a network connection or stored on the device's file system. First, the Decompressor 310 checks the file's header to authenticate that the file is a BFR compressed file. Next, it extracts the other global parameters in the BFR file's header, including the file's dimensions, the number of run-lengths, and the Golomb parameter, as well as the number of colors and the device independent color table. Once the file's header has been decoded, the Decompressor 310 decodes the remaining compressed BFR data into pairs of colors and run-lengths.

The combination of the decoded global parameters, the device independent color table, and pairs of colors and run-lengths forms the device independent intermediate format. This device independent intermediate format is compact and is typically only about 3 times larger than the compressed BFR file. Also, the original graphic is usually about 4 times larger than the intermediate format file. These compression ratios are used only for illustration purposes; the actual compression ratios vary depending on various factors, including the properties and data in the actual graphic and whether or not the graphic was simplified. We have found that the compression ratios easily can range from 0.5 to 500 (see Johan Rade, Jiangying Zhou, “BlueFuel Raster Graphics—Performance Evaluation,” Summus, Inc. (USA) White Paper 2002: 5 Aug. 2002). This feature is particularly useful on mobile devices that have a limited amount of runtime memory and small display units. Such a device may not have enough memory to store the entire decompressed graphic, but may have enough memory to store the intermediate format version of the image (which is 4 times smaller than the entire decompressed image) from which different views of the graphic are generated using the Renderer 320 described in the next section.

The methods employed by the Decompressor 310 are the inverses of those used by the Lossless Compressor 220. If the numbers of colors is two, the graphic being decoded has only two colors, and in the rest of the decoding process, the Decompressor 310 only decodes run-lengths. For two-colored images, the color associated with a run-length is not encoded with each run-length except for the first run. For each run following the first run, the color associated with the run is simply the opposite of the color in the previous run. So, for example, if the color in the previous run is “black,” then the color associated with the current run is “white.”

In order to ensure proper synchronization, the starting mode of the color and run-length predictor is always set to C₃ and the predictor is set to state “B”. Thus, the Decompressor 310 starts the decoding process expecting a new color value and a new run-length value. The decoding technique for color values is simply the inverse of the encoding technique described above. Based on the Golomb parameter, the code word corresponding to the next color is deciphered and mapped to a corresponding color value. Similarly, the run-length value is decoded using a method that is the inverse of the encoding method described above. Again, the code word corresponding to the run-length is extracted from the compressed data and mapped to the run-length.

The next color and run-length pair is decoded based on the prediction state and next prediction code word. Given the state of the predictor and the next prediction code word, the code suffix is uniquely identified by the inverse of the method described for the compression subsystem. If the prediction code word is C₁, the color and run-length are exactly the same as the previous color and run-length and there is no suffix. On the other hand, if the prediction code word is C₂, the color is the same, but the run-length needs to be adjusted. The run-length adjustment is decoded by first reading a single bit that determines whether the adjustment is non-negative (bit is 0) or negative (bit is 1). The size of the run-length adjustment is determined by using the decoding process used to decode run-lengths (described in the previous paragraph). Finally, if the prediction code word is C₃, the color and the run-length are both new and are decoded using the process described in the previous paragraph.

Preferred Renderer

The goal of the Renderer 320 is to create views of a BFRG system-compressed graphic on a particular device. The BFR file format is able to support a wide of range of devices by adding rendering methods tailored to the characteristics of the devices' displays. The displays on mobile devices typically vary from one device to another. Some devices have black-and-white displays and can support only 2 colors. There are other mobile devices that support 4 colors, still others that support 256 colors, etc. Processing power and amount of memory are some of the other characteristics, other than the number of colors supported by the device's display, that can vary from one device to another. In order to achieve the best possible quality on a mobile device, the Renderer 320 preferably applies image-processing techniques adapted to the device's display characteristics.

Conversion of Colors to Device Colors

The device independent color table that has been decoded is processed, and each color in the device independent color table is converted into one or more device dependent colors (multiple colors are generated if anti-aliasing is part of the rendering process). The conversion process is device dependent, and the image processing operations used include color transformations on the color values, anti-aliasing, dithering of the color values, gamma correction, scaling of the color values, and truncation of the color values.

Device-Dependent Rendering

The typical final step before displaying a view of the graphic on the mobile device includes converting the appropriate color and run-lengths to pixel values. The device dependent color table is used to extract the correct color values, the color values used as part of the color and run-length pairs being an index to the color table. Depending on the dimensions of the device's screen, the view of the graphic may not include all the pixels of the graphic. The appropriate pixel values are decoded from the color and run-length pairs. Also, depending on the device's display characteristics, image processing techniques like dithering, gamma correction and others, may be applied to the extracted pixel values. Finally, a view of the graphic fine-tuned to the device's display is created and passed onto the device's display.

The BFR file format has built-in support for fast rendering of multiple views of the graphic. Applications that display images on devices with small screens usually include support for pan and zoom operations. The user can view a small portion of the image at its full resolution or view a larger portion of the image at a lower resolution (a zoomed out view).

A full resolution view of a graphic preferably is generated by using the run-length aspect of the intermediate format to quickly jump to the run-length pair that corresponds to the appropriate pixel of the graphic. Then the display buffer is filled with a color from the device-dependent color table. Views at lower resolutions may require anti-aliasing and dithering, and the anti-aliasing and dithering operations preferably are performed in the same scan of the intermediate data. Furthermore, the color runs help avoid costly operations like divisions and averaging, especially in regions of uniform color. For instance, the average value of a region of uniform color is the color value—no addition and division is required.

Although preferred embodiments of the present invention have been disclosed for illustrative purposes, those skilled in the art will appreciate that various modifications, additions and substitutions are possible, without departing from the scope and spirit of the invention as recited in the accompanying claims.

What is claimed is:

1. A system for graphics compression and display, comprising:
a compression component; and
a decompression component;
wherein said compression component comprises a simplifier module and a lossless compressor module, and
wherein said decompression component comprises a decompressor module and a renderer module.

2. A system as in claim 1, wherein said simplifier module is configured to perform lossy compression.

3. A system as in claim 1, wherein said simplifier module is operable to receive BMP files and to output compressed versions of said received BMP files as image files.

4. A system as in claim 2, wherein said lossy compression comprises histogram-based quantization.

5. A system as in claim 4, wherein said histogram-based quantization comprises:
performing a straight rounding quantization over a raster graphic;
performing histogram-based color reduction over said raster graphic; and
computing local histograms for each pixel position in said raster graphic.

6. A system as in claim 5, wherein only colors within a predefined tolerance level from the color of a current pixel are included in each local histogram.

7. A system as in claim 6, further comprising changing the color of a pixel to match the most common color in its local histogram.

8. A system as in claim 7, wherein said pixel color is changed to match the most common color when the frequency of said most common color exceeds the frequency of the color of said pixel by a pre-defined threshold.

9. A system as in claim 1, wherein said lossless compressor module is operable to perform run-length encoding of color regions.

10. A system as in claim 1, wherein said lossless compressor module is operable to create a device independent color table.

11. A system as in claim 1, wherein said lossless compressor module is operable to estimate encoding parameters.

12. A system as in claim 1, wherein said lossless compressor module comprises a predictor operable to predict upcoming color and run-length.

13. A system as in claim 12, wherein said predictor predicts color and run-length based on a previous row of pixels and previous pixels in a current row.

14. A system as in claim 1, wherein said lossless compressor module uses multi-state Huffman coding.

15. A system as in claim 1, wherein said lossless compressor module uses adaptive Golomb coding of color values.

16. A system as in claim 1, wherein said lossless compressor module uses fixed table prefix coding of run-length values.

17. A system as in claim 1, wherein said decompressor module is operable to receive a compressed file and output a corresponding file that is in a device independent intermediate format.

18. A system as in claim 17, wherein said device independent intermediate format comprises one or more of the following:
decoded global parameters;
a device independent color table; and
pairs of colors and run-lengths.

19. A system as in claim 1, wherein said decompressor module comprises a predictor synchronized to a predictor in said lossless compressor module.

20. A system as in claim 1, wherein said renderer module is operable to receive a decoded device independent color table and convert said table into one or more device dependent colors.

21. A system as in claim 1, wherein said renderer module is operable to perform one or more of the following:
color transformations on color values;
anti-aliasing;
dithering of color values;
gamma correction;
scaling of color values; and
truncation of color values.
